(19) United States
(12) Patent Application Publication
(10) Pub. No.: US 2003/0095353 A1
(43) Pub. Date: May 22, 2003

(54) Method of and apparatus for writing servo signals, and magnetic tape with written servo signals

(75) Inventor: Toru Nakao, Kanagawa (JP)

Correspondence Address: SUGHRUE MION, PLLC, 2100 Pennsylvania Avenue, N.W., Washington, DC, 20037-3213, US

(73) Assignee: FUJI PHOTO FILM CO., LTD.

(21) Appl. No.: 10/270,545

(22) Filed: Oct. 16, 2002

(30) Foreign Application Priority Data
Nov. 19, 2001 (JP) 2001-353093

(51) Int. Cl. G11B 21/02; G11B 5/584

(52) U.S. Cl. 360/75; 360/77.12; 360/77.13

(57) ABSTRACT

A method of writing a servo signal on a servo track of a magnetic tape is disclosed. The method comprises applying a recording current to a servo write head, wherein the recording current includes a plurality of continuous pattern sets formed by way of alternately supplying plus and minus polarities.

### FIELD OF THE INVENTION

The present invention relates to a servo signal writing method and a servo signal writing apparatus for writing a servo signal on a servo track of a magnetic tape while supplying a servo write head with a recording current, and also to a magnetic tape with written servo signals.

### BACKGROUND OF THE INVENTION

In recent years, magnetic tapes with high recording density have been advantageously developed, and as magnetic tapes used for backing up a computer system, there are provided several magnetic tapes with a storage capacity of approximately 100 gigabytes. Therefore, the magnetic tape defines several hundreds of data tracks in its width direction, which results in a very narrow width of each data track and a very narrow width between respective adjoining data tracks. To perform record/reproduction of data signals of this magnetic tape, a magnetic tape recording/reproducing apparatus is equipped with a magnetic head having a large number of narrow data signal recording/reproducing elements. However, the magnetic tape recording/reproducing apparatus for high recording density is not normally provided with data signal recording/reproducing elements as many as the number of the data tracks of the magnetic tape. Therefore, the magnetic head is slightly moved in the direction of the width of the magnetic tape to displace the data signal recording/reproducing elements on the adjoining next data tracks after the magnetic tape is fed from end to end, so that recording/reproducing all the data tracks is carried out by reciprocating the magnetic tape several times.

For this reason, the magnetic tape recording/reproducing apparatus requires that the magnetic head be highly accurately positioned such that each data signal recording/reproducing element accurately positions on the corresponding data track. However, since the magnetic tape is in the form of a thin film, the magnetic tape recording/reproducing apparatus presently forwarding or rewinding the magnetic tape in its longitudinal direction may cause a slight vibration in the width of the magnetic tape. As a result, the position between each data track and its corresponding data signal recording/reproducing element is deviated relatively in the width of the magnetic tape.

In order to regulate a deviation in the width of the magnetic tape, a so-called servo control system has been developed wherein the position of the magnetic head is controlled in the width direction on the basis of a servo signal written on the magnetic tape. In this servo control system, a servo writer writes a servo signal on a servo track of the magnetic tape, and a magnetic data recording/reproducing apparatus carries out the positioning of the magnetic head on the basis of the servo signal that has been readout. The servo control system provides several systems, such as amplitude servo system in which the positioning control is carried out on the basis of the width of a servo pattern that has been read out, timing based servo system in which the positioning control is carried out on the basis of the timing of a servo pattern that has been read out, etc.

In the case of the timing based servo system, a servo signal includes a plurality of nonparallel servo pattern pairs as a unit, wherein each servo pattern inclines at a certain angle with respect to the width direction of the magnetic tape and each servo pattern unit is disposed in the longitudinal direction of the magnetic tape at a certain interval. In order to write such a servo signal, the servo writer is equipped with a servo write head which forms a pair of head gaps in the form of the nonparallel servo pattern pair. By applying a recording current to a coil of the servo write head to generate magnetic flux and by the use of the leakage flux from the pair of head gaps, the servo writer writes a servo signal on the magnetic tape. Meanwhile, the magnetic tape recording/reproducing apparatus is provided with a narrow servo signal reading element made of MR (Magneto Resistive) element at its magnetic head, and reads out the servo signal by utilizing a change of the electric resistance of the MR element corresponding to the external magnetic field (magnetic field from the servo signal). Further, in the magnetic tape recording/reproducing apparatus, the servo signal reading element changes the read-out position in the width direction of the servo pattern unit in accordance with a slight displacement of the magnetic head in the width direction of the magnetic tape after the magnetic tape is forwarded or rewound from end to end.

Magnetic tapes are expected to perform high recording density such as tens of terabytes of storage in the future. Therefore, the number of data tracks of the magnetic tape increases, so that the width of each data track and the width of respective adjoining data tracks become much narrower, and the magnetic layer becomes thinner as the result of lamellation of the magnetic tape per se and increase in linear recording density. For this reason, the magnetic tape recording/reproducing apparatus requires increased number of reciprocation of the magnetic tape to record/reproduce data corresponding to the increased number of data tracks, and the width of each data signal recording/reproducing element and the width of the servo signal reading element are further narrower.

In the conventional timing based servo system as illustrated in FIG. 5, a recording pulse current PC consisting of zero current and plus pulse current is applied as a recording current so as to avoid saturation of the MR element. With the use of this recording pulse current PC, a servo signal SS is written in such a manner that when a plus pulse current of the recording pulse current PC is flown, the magnetic layer is magnetized in one direction by the leakage flux from the pair of servo gaps and a servo pattern pair SP is formed, and when a zero current of the recording pulse current PC is flown, the magnetic layer is not magnetized. Meanwhile, with the use of the servo signal reading element (MR element) the magnetic tape recording/reproducing apparatus detects a change point of the magnetization of the servo signal SS based on a change of the electric resistance, and outputs the change point of magnetization as a read-out signal in the form of a differential wave (voltage value). Therefore, the greater the change of the electric resistance of the MR element, the greater the peak voltage value of the read-out signal of the servo signal SS, which improves the signal-to-noise ratio of the read-out signal. If a change in the quantity of magnetization of the servo signal SS per se is large, or if the read-out region is large due to extended width of the servo signal reading element (MR element), as shown in FIG. 5, the peak voltage value of the read-out signal RSL of the servo signal SS becomes greater (within the range where the MR element is not saturated).

However, with decreasing width of the data tracks due to high recording density, the width of the servo signal reading element becomes narrower, thereby leading to narrow read-out region and small quantity of magnetization which is detectable. Further, the quantity of magnetization of the servo pattern SP becomes smaller with decreasing thickness of the magnetic layer. In other words, the more the magnetic tape is developed in terms of high recording density, the less the change of the quantity of magnetization of the servo signal SS which is detectable by the servo signal reading element. Therefore, as illustrated in FIG. 5, the peak voltage value of the read-out signal RSS becomes smaller and the signal-to-noise ratio of the read-out signal RSS deteriorates. As the result, the magnetic tape recording/reproducing apparatus does not read the servo signal SS accurately and the positioning control of the highly accurate magnetic head is not performed.

The present invention is proposed to provide a servo signal writing method which improves the signal-to-noise ratio of the read-out signal of the servo signal.

### SUMMARY OF THE INVENTION

According to a first aspect of the present invention, there is provided a method of writing a servo signal on a servo track of a magnetic tape, comprising applying a recording current to a servo write head, wherein said recording current includes a plurality of continuous pattern sets formed by way of alternately supplying plus and minus polarities.

Also, there is provided a method of writing a servo signal on a servo track of a magnetic tape while applying a recording current, comprising the steps of: feeding the magnetic tape in contact with a servo write head; and alternately applying plus and minus polarities to the servo write head so as to write a plurality of continuous pattern sets on the servo track during the feed of the magnetic tape.

In these servo signal writing methods, a plurality of servo signals may be simultaneously written on servo tracks formed along a longitudinal direction of the magnetic tape.

According to these servo signal writing methods, on the servo tracks of the magnetic tape, when a plus current of the recording current is applied, a servo pattern region is magnetized in one direction, and when a minus current of the recording current is applied, a servo pattern region adjacent to the servo pattern region that has been magnetized in one direction is magnetized in the reversed direction. Therefore, since each servo signal written on the magnetic tape includes adjacent magnetized regions which are magnetized in the reversed direction to each other, a change in the quantity of magnetization becomes greater. As the result, the read-out signal of the servo signal takes a large value at the peak voltage value, which improves the signal-to-noise ratio of the read-out signal.

In the aforementioned servo signal writing methods, a pulse generation means generates the recording current and supplies it to the servo write head, and a control means controls timing at which a pulse current having a plus polarity and a pulse current having a minus polarity are generated alternately.

Further, in the aforementioned servo signal writing methods, the servo write head is provided with a pair of head gaps in the form of a nonparallel servo pattern pair, each servo pattern inclining at a predetermined angle with respect to a width of the magnetic tape.

In the case that a plurality of servo signals are simultaneously written on servo tracks formed along a longitudinal direction of the magnetic tape, the servo write head is provided with a plurality pairs of head gaps in the form of a nonparallel servo pattern pair, each servo pattern inclining at a predetermined angle with respect to a width of the magnetic tape.

According to a second aspect of the present invention, there is provided an apparatus for writing a servo signal on a servo track of a magnetic tape comprising: a servo write head to which is applied a recording current including a plurality of continuous pattern sets formed by way of alternately supplying plus and minus polarities; a pulse generation means generating a pulse current as the recording current and supplying it to the servo write head; a control means controlling timing at which a pulse current having a plus polarity and a pulse current having a minus polarity are generated alternately; and a drive means for feeding the magnetic tape in contact with the magnetic head.

In the aforementioned apparatus, the servo write head is provided with a plurality pairs of head gaps in the form of a nonparallel servo pattern pair, each servo pattern inclining at a predetermined angle with respect to a width of the magnetic tape, and the each pair of head gaps is supplied with the recording current.

According to a third aspect of the present invention, there is provided a magnetic tape on which is written a plurality of servo signals, each having servo pattern regions alternately magnetized in reverse direction to each other.

In the aforementioned magnetic tape, each of the servo signals includes a plurality of continuous pattern sets in the form of a nonparallel servo pattern pair, each servo pattern inclining at a predetermined angle with respect to a width of the magnetic tape.

### BRIEF DESCRIPTION OF THE DRAWINGS

Preferred embodiments of the present invention will be described below, by way of example only, with reference to the accompanying drawings, in which:

FIG. 1 is a view illustrating the whole arrangement of a servo control system according to one embodiment of the invention;

FIG. 2 is a schematic plan view illustrating a servo write head of a servo writer shown in FIG. 1;

FIG. 3 is a schematic plan view illustrating a magnetic head of a magnetic tape recording/reproducing apparatus shown in FIG. 1;

FIG. 4 is an explanatory view illustrating writing/reading a servo signal on and from a magnetic tape in the servo control system; and

FIG. 5 is an explanatory view illustrating writing/reading a servo signal on and from a magnetic tape in a conventional servo control system.

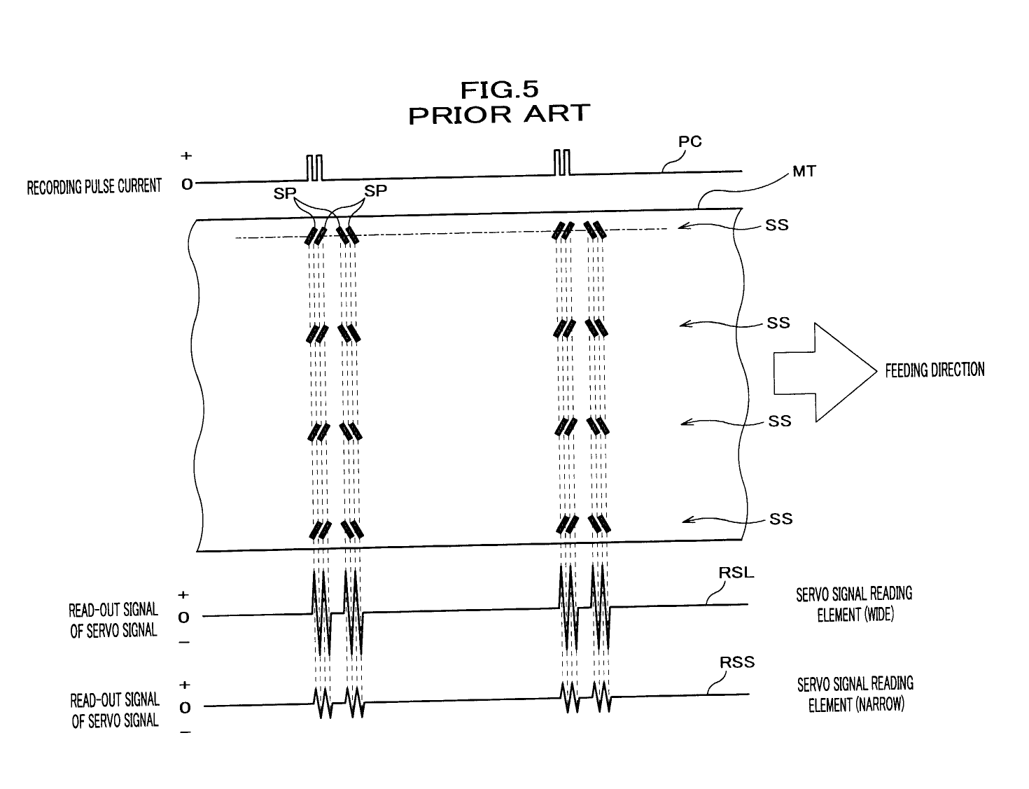

### DESCRIPTION OF THE PREFERRED EMBODIMENTS

A preferred embodiment of a servo signal writing method, a servo signal writing apparatus, and a magnetic tape according to the present invention will be described with reference to the attached drawings.

According to the present invention, in order to improve the read-out accuracy of a servo signal at a recording/reproducing side for a data signal of a magnetic tape, a recording current having alternate plus and minus polarities is applied when a servo writer writes a servo signal on the magnetic tape. When doing so, a servo signal is written on a servo track of the magnetic tape, which servo signal alternately changes its direction of magnetization by 180 degrees within adjacent servo pattern regions. For this reason, a change in the quantity of magnetization becomes greater between adjacent servo patterns, and the peak voltage value of a read-out signal of the servo signal becomes greater at the recording/reproducing side for the data signal of the magnetic tape, thereby improving the read-out accuracy.

In this preferred embodiment, a description will be given of a servo control system of the timing based servo type including a servo signal writing side and a servo signal reading side. The servo control system according to this embodiment consists of a servo writer for writing a plurality of servo signals on a magnetic tape of a magnetic tape cartridge and a magnetic tape recording/reproducing apparatus for recording/reproducing data signals on and from the magnetic tape of the magnetic tape cartridge. This magnetic tape cartridge is used for a computer with high recording density.

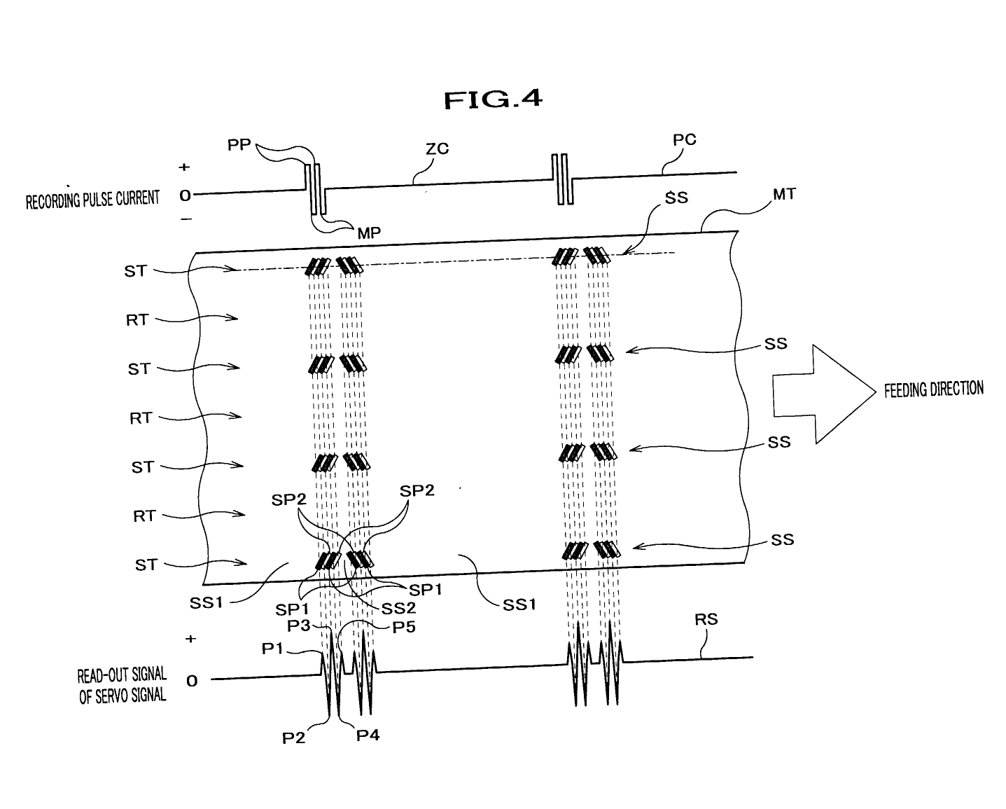

Before describing the servo control system S, the magnetic tape MT of the magnetic tape cartridge C will be explained with reference to FIG. 4. FIG. 4 is an explanatory view illustrating writing/reading a servo signal SS on and from a magnetic tape MT in the servo control system S.

For the purpose of achieving high recording density, the magnetic tape MT is very thin in thickness, and has three recording tracks RT and four servo tracks ST along its longitudinal direction. The servo tracks ST are located such that each recording track RT is sandwiched therebetween. Each recording track RT has 96 data tracks, and a data signal is recorded on each data track. A servo signal SS is written on each servo track ST. The servo signal SS includes four adjacent nonparallel servo pattern pairs SP1, SP2, SP1, SP2 as a unit (also referred to as a servo pattern unit), wherein each servo pattern inclines at a predetermined angle with respect to the width of the magnetic tape MT and each servo pattern unit is disposed in the longitudinal direction of the magnetic tape MT at a predetermined interval. The adjacent servo patterns SP1 and SP2 are different in the direction of magnetization by 180 degrees. Each servo pattern SP1, SP2 has a predetermined width in its longitudinal direction. In this preferred embodiment, the direction of magnetization for the servo pattern SP1 is referred to as a first direction, and the direction of magnetization for the servo pattern SP2 is referred to as a second direction.

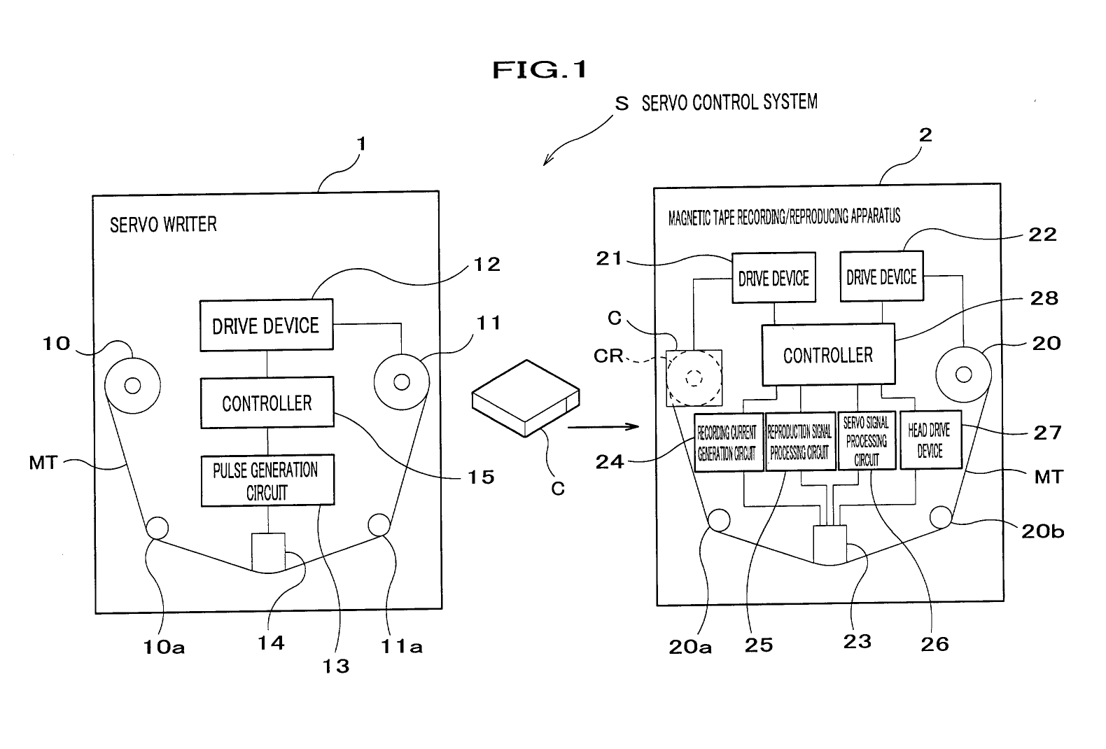

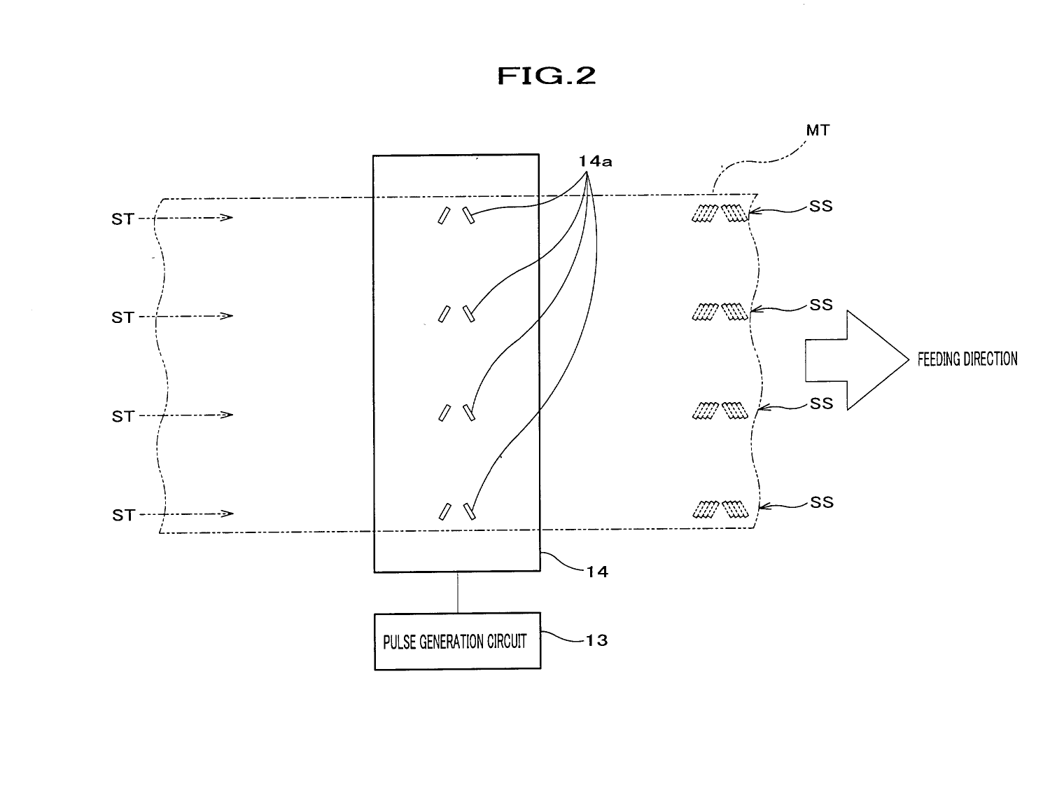

With reference to FIGS. 1, 2 and 4, the construction of the servo writer 1 will be described. FIG. 1 is a view illustrating the whole arrangement of a servo control system according to one embodiment of the invention. FIG. 2 is a schematic plan view illustrating a servo write head of a servo writer shown in FIG. 1.

The servo writer 1 mainly comprises a feed-out reel 10, a wind-up reel 11, a drive device 12, a pulse generation circuit 13, a servo write head 14, and a controller 15. Further, the servo writer 1 is equipped with a non-illustrated power supply, a non-illustrated cleaning device for cleaning the magnetic tape MT, and a non-illustrated verify device for checking written servo signals.

Prior to writing servo signals SS, a raw and wide magnetic tape in the form of a roll is cut along its longitudinal direction to prepare a magnetic tape roll having a large diameter. The magnetic tape roll set on the feed-out reel 10 is fed out upon writing servo signals SS. The magnetic tape MT fed out from the feed-out reel 10 is guided by a guide 10a and travels to a servo write head 14. After the servo write head 14 writes servo signals SS on the magnetic tape MT, the magnetic tape MT is guided by a guide 11a and travels to the wind-up reel 11. The wind-up reel 11 is rotatively driven by the drive device 12 so as to wind up the magnetic tape MT on which is written servo signals SS.

The drive device 12 rotatively drives the wind-up reel 11. The drive device 12 comprises a non-illustrated motor, a non-illustrated motor drive circuit for supplying an electric current to the motor, and non-illustrated gears for connecting the motor shaft and the wind-up reel 11. The drive device 12 generates a motor current at a motor drive circuit on the basis of a motor current signal from the controller 15, and supplies the motor current to the motor. Further, the drive device 12 transmits the rotating force of the motor to the wind-up reel 11 through the gears, and rotatively drives the wind-up reel 11.

The pulse generation circuit 13 is a circuit for supplying a recording pulse current PC to the servo write head 14 (FIG. 4), and is equipped with various electric parts. As shown in FIG. 4, the pulse generation circuit 13 generates a recording pulse current PC on the basis of a pulse control signal from the controller 15, the recording pulse current PC consisting of a repeated pattern, which includes a series of continuous pulse current generated in the order of a plus pulse current PP having a plus polarity, a minus pulse current MP having a minus polarity, a plus pulse current PP, and a minus pulse current MP, and a zero current ZC followed after the series of continuous pulse current and not generating a current for a predetermined time. The pulse generation circuit 13 supplies this recording pulse current PC to a non-illustrated coil of the servo write head 14. The current value of the pulse current PP, MP is sufficient to magnetize the magnetic layer of the magnetic tape MT by means of the leakage flux from a pair of head gaps, and is determined in consideration of characteristics of the coil of the servo write head 14. The pulse width (time) of the pulse current PP, MP defines the predetermined width of the servo pattern SP1, SP2 in its longitudinal direction. As shown in FIG. 2, the pulse width is determined in consideration of feed speed of the magnetic tape MT, shape of the head gap 14a provided at the servo write head 14, etc. Further, the predetermined time for applying the zero current ZC may vary within the time interval between the series of continuous pulse currents, and is determined in consideration of feed speed of the magnetic tape MT, etc.

In this preferred embodiment, the recording pulse current PC corresponds to the recording current defined in the claims.

The servo write head 14 is a magnetic head for writing servo signals SS. As best seen in FIG. 2, the servo write head 14 is equipped with a non-illustrated coil for generating magnetic flux, and forms a plurality pairs of head gaps 14a. The servo write head 14 is provided with four pairs of head gaps 14a which are disposed in line at positions corresponding to the width positions of four servo tracks ST of the magnetic tape MT. The head gaps 14a are formed by lithography which makes use of semiconductor technology. Each head gap 14a inclines at a predetermined angle with respect to the width of the servo write head 14 in such a manner that the respective pairs of head gaps 14a are nonparallel and converging to one point. Upon supplying a recording pulse current PC from the pulse generation circuit 13 to the servo write head 14, the magnetic layer of the magnetic tape MT is magnetized in a first direction by magnetic flux from the pair of head gaps 14a in the case that a plus pulse current PP flows into the coil, and the magnetic layer of the magnetic tape MT is magnetized in a second direction by magnetic flux from the pair of head gaps 14a in the case that a minus pulse current MP flows into the coil, and further the magnetic layer of the magnetic tape MT is not magnetized in the case of a zero current ZC. Therefore, the servo pattern pair SP1, SP1 magnetized in the first direction, the servo pattern pair SP2, SP2 magnetized in the second direction, the servo pattern pair SP1, SP1, and the servo pattern pair SP2, SP2 are adjacently written in the order on each servo track ST of the magnetic tape MT, and no servo pattern is written in the region SS1 having a predetermined interval (FIG. 4). In a servo pattern unit, no servo pattern is written in a region SS2 sandwiched between adjacent nonparallel servo patterns SP2, SP1 (FIG. 4).

The controller 15 controls movement of each part of the servo writer 1, and is equipped with a CPU (Central Processing Unit) and various memories, etc. In order to achieve a constant feed speed of the magnetic tape MT upon writing servo signals SS, the controller 15 generates a motor current signal for controlling a motor current of the drive device 12 and transmits the same to the drive device 12. Further, the controller 15 generates a pulse control signal for controlling the current value, the pulse width and the generation timing of the pulse current PP, MP of the recording pulse current PC so as to set the servo signal SS which defines the longitudinal width of the servo pattern SP1, SP2 or the predetermined interval between two adjoining servo pattern units, and transmits the same to the pulse generation circuit 13. In other words, the controller 15 generates a pulse pattern such that a plus pulse current PP, a minus pulse current MP, a plus pulse current PP, and a minus pulse current are generated in the order and thereafter no electric current is generated for a predetermined time to thereby generate a recording pulse current PC.

The magnetic tape MT on which is written servo signals SS is then cut by the product length of the magnetic tape cartridge C, and is wound by a cartridge reel CR with a smaller diameter for use in the magnetic tape cartridge. This cartridge reel CR is assembled into a cartridge to produce a magnetic tape cartridge C as a commercial product.

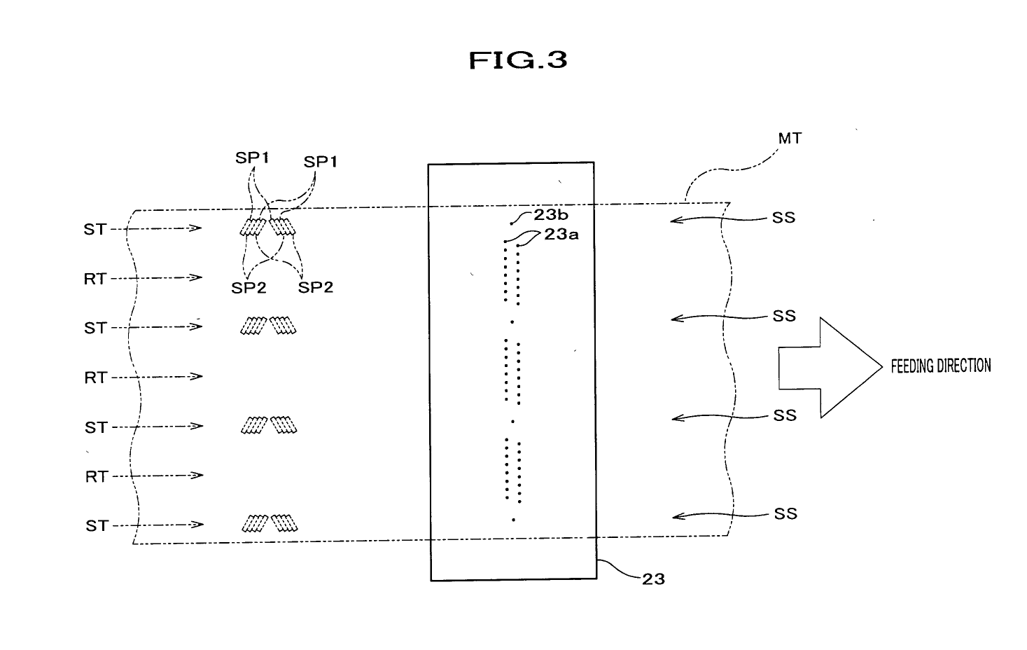

With reference to FIGS. 1, 3, and 4, the construction of the magnetic tape recording/reproducing apparatus 2 will be described. Herein, FIG. 3 is a schematic plan view illustrating a magnetic head 23 of the magnetic tape recording/reproducing apparatus 2.

The magnetic tape recording/reproducing apparatus 2 mainly comprises a reel 20, drive devices 21, 22, a magnetic head 23, a recording current generation circuit 24, a reproduction signal processing circuit 25, a servo signal processing circuit 26, a head drive device 27, and a controller 28. The magnetic tape recording/reproducing apparatus 2 is also equipped with a non-illustrated power supply, a non-illustrated device for ejecting/slotting a magnetic tape cartridge C, a non-illustrated device for pulling out the magnetic tape MT from the magnetic tape cartridge C, etc. The magnetic tape recording/reproducing apparatus 2 is connected with a computer. The magnetic tape recording/reproducing apparatus 2 records data that is inputted from the computer on the magnetic tape MT of the magnetic tape cartridge C as a data signal, or reproduces the data signal from the magnetic tape MT of the magnetic tape cartridge C so as to output the data to the computer.

As previously described, the magnetic tape MT has 288 (=3×96) data tracks. The magnetic tape recording/reproducing apparatus 2 feeds the magnetic tape six times from end to end (for the length of the tape), that is three round-feeds, to record/reproduce data signals on or from all the data tracks. Data signals for 48 (=3×16) data tracks can be recorded/reproduced for one feed. In the magnetic tape recording/reproducing apparatus 2, when the reel 20 functions as a wind-up reel, the cartridge reel CR of the magnetic tape cartridge C functions as a feed-out reel, and when the reel 20 functions as a feed-out reel, the cartridge reel CR of the magnetic tape cartridge C functions as a wind-up reel.

Upon insertion of the magnetic tape cartridge C, the magnetic tape recording/reproducing apparatus 2 pulls out the leading end of the magnetic tape MT from the magnetic tape cartridge C, and connects the leading end to the hub of the reel 20. During the forward feed of the magnetic tape MT, the cartridge reel CR feeds out the magnetic tape MT. The magnetic tape MT fed out from the cartridge reel CR is guided by a guide 20a and travels to the magnetic head 23. After the magnetic head 23 records/reproduces the data signals, the magnetic tape MT is guided by a guide 20b and travels to the reel 20. The reel 20 is rotatively driven by the drive device 22 so as to wind up the magnetic tape MT on/from which the data signals are written/reproduced. Meanwhile, during the reverse feed of the magnetic tape MT, the reel 20 feeds out the magnetic tape MT. The magnetic tape MT fed out from the reel 20 is guided by the guide 20b and travels to the magnetic head 23. After the magnetic head 23 records/reproduces the data signals, the magnetic tape MT is guided by the guide 20a and travels to the cartridge reel CR. The cartridge reel CR is rotatively driven by the drive device 21 so as to wind up the magnetic tape MT on/from which the data signal are written/reproduced.

The drive device 21 rotatively drives the cartridge reel CR. The drive device 21 is substantially the same device as the drive device 12. The drive device 22 rotatively drives the reel 20, and is substantially the same device as the drive device 12.

The magnetic head 23 records/reproduces the data signals and reads the servo signals SS. As seen in FIG. 3, the magnetic head 23 is equipped with data signal recording/reproducing elements 23a and servo signal reading elements 23b. The magnetic head 23 is provided with 16 data signal recording/reproducing elements 23a which are disposed alternately in two lines at positions corresponding to the width positions of three recording tracks RT of the magnetic tape MT. Also, the magnetic head 23 is provided with four servo signal reading elements 23b which are disposed in line at positions corresponding to the width positions of four servo tracks ST of the magnetic tape MT. Each data signal recording/reproducing element 23a is disposed at a position corresponding to the width position of each non-illustrated data track, and the data signal recording/reproducing element 23a is made of an MR element with very narrow width. The total of 48 data signal recording/reproducing elements 23a are provided, and by feeding the magnetic tape MT six times (three round-feeds) while slightly displacing the magnetic head 23 along the width direction of the magnetic tape MT, the magnetic head 23 processes all the illustrated 288 data tracks. Meanwhile, each servo signal reading element 23b is made of an MR element with very narrow width (e.g., several to 10 μm), and by feeding the magnetic tape MT six times (three round-feeds) while slightly displacing the magnetic head 23 along the width direction of the magnetic tape MT, the servo signal reading element 23b reads out the servo signal SS from six different positions along its width.

The servo signal reading element 23b reads out the servo signal SS, by means of electric resistance effect of the MR element, based on a change of the electric resistance of the MR element corresponding to the external magnetic field due to magnetization of the magnetic layer of the magnetic tape MT. The MR element non-linearly changes its change rate of the electric resistance with respect to the external magnetic field and is saturated with increasing external magnetic field (i.e., increasing the quantity of magnetization). Therefore, bias magnetic field is applied to the servo signal reading element 23b, and only a region where the change rate of the electric resistance becomes linear is used. In the servo signal reading element 23b, the region readable from the servo patterns SP1, SP2 is very small as the width of the servo signal reading element 23b is very small. Since the quantity of magnetization at the servo patterns SP1, SP2, which are written on the magnetic tape MT having a very thin magnetic layer, is very small and the region readable from the servo patterns SP1, SP2 is also small, the external magnetic field does not become greater. Therefore, the servo signal reading element 23b does not read out the servo signal at the saturation region.

The recording current generation circuit 24 is a circuit for supplying a recording current to each data signal recording/reproducing element 23a of the magnetic head 23, and is equipped with various electric parts. The recording current generation circuit 24 generates a recording current on the basis of a recording current control signal from the controller 28, and supplies this recording current to the magnetic head 23.

The reproduction signal processing circuit 25 is a circuit for converting a data signal reproduced at the data signal recording/reproducing element 23a of the magnetic head 23 into a signal operable at the controller 28, and is equipped with various electric parts. The reproduction signal processing circuit 25 converts the data signal based on a change of the electric resistance of the MR element from the data signal recording/reproducing element 23a, and transmits this converted signal to the controller 28.

The servo signal processing circuit 26 is a circuit for converting a servo signal SS read out at the servo signal reading element 23b of the magnetic head 23 into a signal operable at the controller 28, and is equipped with various electric parts. In the servo signal processing circuit 26, a constant current is applied to the servo signal reading element 23b (MR element), and the voltage change corresponding to the change of the electric resistance of the MR element is amplified. The servo signal processing circuit 26 converts a change point of magnetization into a read-out signal RS in the form of a differential wave (voltage value) based on the amplified voltage change (FIG. 4). The servo signal processing circuit 26 transmits this read-out signal RS to the controller 28.

As seen in FIG. 4, the read-out signal RS comprises a smaller peak voltage point P1 at a change point of magnetization from the non-magnetized region SS1 to the servo pattern SP1, a greater peak voltage point P2 at a change point of magnetization from the servo pattern SP1 to the servo pattern SP2, a greater peak voltage point P3 at a change point from the servo pattern SP2 to the servo pattern SP1, a greater peak voltage point P4 at a change point from the servo pattern SP1 to the servo pattern SP2, and a smaller peak voltage point P5 at a change point from the servo pattern SP2 to the non-magnetized region SS2. In other words, at the change point between the servo pattern SP1 and the servo pattern SP2, the quantity of magnetization changes between magnetization in the first direction and magnetization in the second direction, wherein the direction of magnetization differs by 180 degrees. Therefore, when compared the change point between the servo patterns SP1, SP2 with the change point at the non-magnetized region SS1, SS2, the quantity of magnetization changes almost twice as much as that at the non-magnetized region SS1, SS2. The absolute value of the greater peak voltage points P2, P3, P4 becomes almost twice as large as that of the smaller peak voltage points P1, P5.

The head drive device 27 displaces or moves the magnetic head 23 in the width direction of the magnetic tape MT, and is equipped with a non-illustrated voice coil motor, etc. The head drive device 27 generates a drive force at the voice coil motor based on a head control signal from the controller 28, and by this drive force displaces the magnetic head 23 in the width direction of the magnetic tape MT. The displacement of the magnetic head 23 in the width direction includes two positional displacements, i.e., a positional displacement for changing, after feeding the magnetic tape MT from end to end, the data signal recording/reproducing elements 23a from the corresponding data tracks to the adjoining data tracks, and a positional displacement based on the servo signal SS for correcting a relative deviation between each data track and the corresponding data signal recording/reproducing element 23a.

The controller 28 controls movements of each part of the magnetic tape recording/reproducing apparatus 2, and is equipped with a CPU and various memories, etc. In order to achieve a constant feed speed of the magnetic tape MT upon recording/reproducing data signals, the controller 28 generates a motor current signal for controlling a motor current of the drive device 21 or a motor current of the drive device 22 and transmits the same to the drive device 21 or the drive device 22. The controller 28 also generates a recording current control signal based on the data inputted from the external at the time of recording the data signals, and transmits this recording current control signal to the recording current generation circuit 24. Further, upon reproducing the data signals, the controller 28 converts the reproduction signals of the data signals from the reproduction signal processing circuit 25 into the data format to be outputted to the external, and outputs the thus converted data to the external.

Further, as seen in FIG. 4, the controller 28 receives a read-out signal RS from the servo signal processing circuit 26 upon receiving/reproducing the data signals, and based on this read-out signal RS the controller 28 detects a deviation of the magnetic head 23 in the width direction of the magnetic tape MT. The controller 28 detects a deviation of the magnetic head 23 in the width direction of the magnetic tape MT based on a ratio of the short interval between one nonparallel servo pattern pair SP1, SP2 against the long interval from one servo pattern SP1 or SP2 to the corresponding servo pattern SP1 or SP2 located in the adjoining servo pattern unit and positioned at the corresponding position of the one servo pattern SP1 or SP2. In this event, since the controller 28 utilizes the greater peak voltage points P2, P3, P4 of the read-out signal RS for obtaining the short interval and the long interval, it is possible to accurately obtain the short interval and the long interval from the servo signals SS. The controller 28 then generates a head control signal, wherein the positional displacement amount for correcting a deviation in the width direction based on the servo signals SS is taken into consideration on the positional displacement amount in the width direction for changing the data signal recording/reproducing elements 23a from the corresponding data tracks to the adjoining data tracks after feeding the magnetic tape MT from end to end, and transmits this generated head control signal to the head drive device 27. The controller 28 receives four read-out signals RS corresponding to the four servo signals SS. However, the controller 28 detects a deviation in the width direction on the basis of only one read-out signal RS, and the other three read-out signals RS are spares in case of improperly reading out the servo signals SS.

Finally, a series of operations from writing servo signals SS to reading out servo signals SS in the servo control system S will be described with reference to FIGS. 1 through 3.

Upon writing servo signals SS, the servo writer 1 generates a recording pulse current PC wherein a current including a pulse train consisting of a plus pulse current PP, a minus pulse current MP, a plus pulse current PP, and a minus pulse current MP in the order flows at a predetermined interval, and flows the thus generated recording pulse current PC into the coil of the servo write head 14. When the plus pulse current PP flows, the servo writer 1 writes a servo pattern SP1 magnetized in the first direction on each servo track ST of the magnetic tape MT. When the minus pulse current MP flows, the servo writer 1 writes a servo pattern SP2 magnetized in the second direction on each servo track ST of the magnetic tape MT. And the servo writer 1 does not write any servo pattern in the case of a zero current ZC.

When the servo writer 1 completes the writing operation, a plurality of servo signals SS are written on the respective servo tracks ST, each of the servo signals which includes a set of a servo pattern SP1, a servo pattern SP2, a servo pattern SP1, and a servo pattern SP2 as a unit, and this unit being disposed at a predetermined interval. In this unit, the direction of magnetization differs by 180 degrees at one side and the other side of adjacent servo patterns in the order of the first direction, the second direction, the first direction, and the second direction. Therefore, at the change point of magnetization between the servo pattern SP1 and the servo pattern SP2, the quantity of magnetization changes twice as much as the quantity of magnetization at the servo pattern SP1 per se or the servo pattern SP2 per se.

Upon reading out the servo signals SS, the servo signal reading elements 23b of the magnetic tape recording/reproducing apparatus 2 reads out the servo signals SS written on the magnetic tape MT and generates a read-out signal RS. When reading out a change point of magnetization from the non-magnetized region SS1, SS2 to the servo pattern SP1, the electric resistance of the MR element increases for the basic quantity at the servo signal reading element 23b, and the read-out signal RS takes a plus-side peak voltage P1 of the basic voltage value. When reading out a change point of magnetization from the servo pattern SP1 to the servo pattern SP2, the electric resistance of the MR element decreases twice as much as the basic quantity at the servo signal reading element 23b, and the read-out signal RS takes a minus-side peak voltage P2, P4 twice as much as the basic voltage value. When reading out a change point of magnetization from the servo pattern SP2 to the servo pattern SP1, the electric resistance of the MR element increases twice as much as the basic quantity at the servo signal reading element 23b, and the read-out signal RS takes a plus-side peak voltage P3 twice as much as the basic voltage value. When reading out a change point of magnetization from the servo pattern SP2 to the non-magnetized region SS1, SS2, the electric resistance of the MR element increases for the basic quantity at the servo signal reading element 23b, and the read-out signal RS takes a plus-side peak voltage P5 of the basic voltage value.

In other words, since a plus pulse current PP and a minus pulse current MP changing over the plus and minus polarities are applied as a recording pulse current PC, in the read-out signal RS of the servo signal SS, the voltage value of the peak voltage P2, P3, P4 becomes almost double when compared with a conventional recording pulse current changing at a single polarity. For this reason, the signal-to-noise ratio of the read-out signal RS of the servo signal SS that has been read out by the servo signal reading element 23b is improved. As a result, regardless of very narrow width of the servo signal reading element 23b and very thin thickness of the magnetic tape MT, the magnetic tape recording/reproducing apparatus 2 accurately reads out the servo signals SS and thus highly accurately controls the position of the magnetic head 23.

While the present invention has been described in detail and with reference to specific embodiments thereof, it will be apparent to one skilled in the art that various changes and modifications can be made therein without departing from the spirit and scope thereof.

For example, the recording current has been described in the preferred embodiments such as to include alternately generating two pulse currents having a plus polarity and two pulse currents having a minus polarity. However, the present invention is not limited to such pattern and various patterns may be arbitrarily set, such as a pattern starting with a minus polarity, or a pattern in which the number of alternation between the plus polarity and the minus polarity (at least one) or the wave shape thereof varies. Also, a pattern starting with a plus polarity and ended with a plus polarity may be possible as long as the recording current includes alternately generated plus and minus polarities.

In the preferred embodiment of the invention, the magnetic tape MT has been described such as to include 3 recording tracks, 288 data tracks, nonparallel servo pattern pairs each converging to one point, and four servo pattern pairs as a unit. However, the present invention is not limited to this specific number or shape, and may vary arbitrarily.

Further, as the read-out side for reading the servo signals, the magnetic tape recording/reproducing apparatus has been exemplified. However, a magnetic tape recording apparatus dedicated for use in recording or a magnetic tape reproducing apparatus dedicated for reproducing may be employed. Also, instead of the data signal recording/reproducing element used both for recording and reproducing a data signal, an element dedicated for recording a data signal or an element dedicated for reproducing a data signal may be employed.

Further, in the preferred embodiment of the invention, an MR element is utilized for the magnetic head of the magnetic tape recording/reproducing apparatus. However, other constructions such as a magnetic tape utilizing electromagnetic induction of a coil may be used.

Furthermore, in the preferred embodiment, data signals are recorded/reproduced on and from all the data tracks of the magnetic tape by feeding the magnetic tape six times (three round-feeds) from end to end. However, the number of feeds of the magnetic tape may vary in accordance with recording capacity of the magnetic tape, width of the servo tracks, width of the data tracks, width of an element of the magnetic head, etc.

What is claimed is:

1. A method of writing a servo signal on a servo track of a magnetic tape, comprising applying a recording current to a servo write head, wherein said recording current includes a plurality of continuous pattern sets formed by way of alternately supplying plus and minus polarities.

2. A method as claimed in claim 1, wherein a plurality of servo signals are simultaneously written on servo tracks formed along a longitudinal direction of the magnetic tape.

3. A method as claimed in claim 1, wherein a pulse generation means generates said recording current and supplies it to the servo write head, and wherein a control means controls timing at which a pulse current having a plus polarity and a pulse current having a minus polarity are generated alternately.

4. A method as claimed in claim 2 wherein a pulse generation means generates said recording current and supplies it to the servo write head, and wherein a control means controls timing at which a pulse current having a plus polarity and a pulse current having a minus polarity are generated alternately.

5. A method as claimed in claim 1, wherein said servo write head is provided with a pair of head gaps in the form of a nonparallel servo pattern pair, each servo pattern inclining at a predetermined angle with respect to a width of the magnetic tape.

6. A method as claimed in claim 2, wherein said servo write head is provided with a plurality pairs of head gaps in the form of a nonparallel servo pattern pair, each servo pattern inclining at a predetermined angle with respect to a width of the magnetic tape.

7. A method as claimed in claim 3, wherein said servo write head is provided with a pair of head gaps in the form of a nonparallel servo pattern pair, each servo pattern inclining at a predetermined angle with respect to a width of the magnetic tape.

8. A method as claimed in claim 4, wherein said servo write head is provided with a plurality pairs of head gaps in the form of a nonparallel servo pattern pair, each servo pattern inclining at a predetermined angle with respect to a width of the magnetic tape.

9. A method of writing a servo signal on a servo track of a magnetic tape while applying a recording current, comprising the steps of:
feeding the magnetic tape in contact with a servo write head; and
alternately applying plus and minus polarities to the servo write head so as to write a plurality of continuous pattern sets on the servo track during the feed of the magnetic tape.

10. A method as claimed in claim 9, wherein a plurality of servo signals are simultaneously written on servo tracks formed along a longitudinal direction of the magnetic tape.

11. A method as claimed in claim 9, wherein a pulse generation means generates said recording current and supplies it to the servo write head, and wherein a control means controls timing at which a pulse current having a plus polarity and a pulse current having a minus polarity are generated alternately.

12. A method as claimed in claim 10, wherein a pulse generation means generates said recording current and supplies it to the servo write head, and wherein a control means controls timing at which a pulse current having a plus polarity and a pulse current having a minus polarity are generated alternately.

13. A method as claimed in claim 9, wherein said servo write head is provided with a pair of head gaps in the form of a nonparallel servo pattern pair, each servo pattern inclining at a predetermined angle with respect to a width of the magnetic tape.

14. A method as claimed in claim 10, wherein said servo write head is provided with a plurality pairs of head gaps in the form of a nonparallel servo pattern pair, each servo pattern inclining at a predetermined angle with respect to a width of the magnetic tape.

15. A method as claimed in claim 11, wherein said servo write head is provided with a pair of head gaps in the form of a nonparallel servo pattern pair, each servo pattern inclining at a predetermined angle with respect to a width of the magnetic tape.

16. A method as claimed in claim 12, wherein said servo write head is provided with a plurality pairs of head gaps in the form of a nonparallel servo pattern pair, each servo pattern inclining at a predetermined angle with respect to a width of the magnetic tape.

17. An apparatus for writing a servo signal on a servo track of a magnetic tape comprising:
a servo write head to which is applied a recording current including a plurality of continuous pattern sets formed by way of alternately supplying plus and minus polarities;
a pulse generation means generating a pulse current as the recording current and supplying it to the servo write head;
a control means controlling timing at which a pulse current having a plus polarity and a pulse current having a minus polarity are generated alternately; and
a drive means for feeding the magnetic tape in contact with the magnetic head.

18. An apparatus as claimed in claim 17, wherein said servo write head is provided with a plurality pairs of head gaps in the form of a nonparallel servo pattern pair, each servo pattern inclining at a predetermined angle with respect to a width of the magnetic tape, and wherein said each pair of head gaps is supplied with the recording current.

19. A magnetic tape on which is written a plurality of servo signals, each having servo pattern regions alternately magnetized in reverse direction to each other.

20. A magnetic tape as claimed in claim 19, wherein each of said servo signals includes a plurality of continuous pattern sets in the form of a nonparallel servo pattern pair, each servo pattern inclining at a predetermined angle with respect to a width of the magnetic tape.
